(19) United States
(12) Patent Application Publication
(10) Pub. No.: US 2019/0315011 A1
(43) Pub. Date: Oct. 17, 2019

(54) Alignment of Film in a Conversion Station

(71) Applicant: 3M INNOVATIVE PROPERTIES COMPANY, St. Paul, MN (US)

(72) Inventors: Steven P. Floeder, Schoreview, MN (US); Steven R. Brindle, St. Paul, MN (US); Nathaniel S. Rowekamp, Inver Grove Heights, MN (US); Thomas H. Schultz, New Berlin, WI (US)

(21) Appl. No.: 16/464,767

(22) PCT Filed: Nov. 30, 2017
(86) PCT No.: PCT/US2017/063858

§ 371 Date: May 29, 2019

Related U.S. Application Data
(60) Provisional application No. 62/428,954, filed on Dec. 1, 2016.
(60) Provisional application No. 62/430,197, filed on Dec. 5, 2016.

(51) Int. Cl. B26D 5/00; B23K 26/08; B23K 26/38; B23K 37/02; B23K 37/04; B26D 5/30; B26D 7/01; B26F 1/40

(52) U.S. Cl. CPC B26D 5/007; B23K 26/0846; B23K 26/38; B23K 37/0211; B23K 2101/16; B26D 5/30; B26D 7/015; B26F 1/40; B23K 37/0408

(57) ABSTRACT

A conversion station (300) comprising a mechanism (240) operable to support at least some portion of a web (250), a conversion device located above the mechanism (240), the conversion device operable to traverse a conversion zone (244) located below the conversion device to bring a cutting member into contact with the web (250) to convert the web (250) into one or more individual products (201A, 202A; 201B, 202B; 201C, 202C), an image capturing device (260) located above the mechanism (240) and adjacent to the conversion device but outside the conversion zone (244), the image capturing device (260) positioned at a non-perpendicular imaging angle (271) relative to a surface plane (270) of the web (250), the image capturing device (260) operable to capture image information (261, 263) by imaging the one or more features located on the web (250) while the features are positioned within the conversion zone (244), and a control system operable to align the web (250) within the conversion zone (244) based on the image information (261, 263).

### TECHNICAL FIELD

The disclosure relates to methods and systems for alignment and conversion processes used for producing a film product from a web.

### BACKGROUND

Manufacturing processes for making various types of films, such as transparent polyester films, involve manufacturing the films in long continuous sheets, referred to as a web. The web itself is generally a material having a fixed dimension in one direction (“crossweb direction”) and either a predetermined or indeterminate length in the orthogonal direction (“downweb direction”). The web can have various features, such as printed markings, applied to one or both surfaces of the film. In addition, one or more features, such as markings, may be embedded within the film, wherein the features are visible through the surface(s) of the film.

In general, the web is typically converted into a plurality of individual products. For example, a web can include a series of designated areas of the film, in some examples the designated areas having a width dimension and a length dimension, which are to be separated from the web using a conversion process in order to provide individual products. Examples of individual products include a cover film for a display such as a computer monitor, or a cover sheet or layer for a display screen of a mobile device such as a cellular phone.

### SUMMARY

In general, this disclosure describes conversion stations and alignment processes that are based on a printed mark or other printing or feature that is to remain on the individual product itself after the individual product has been converted rather than a fiducial mark or another marking located on a portion of the web outside an area designated to become the individual product. This approach provides advantages in that alignment is now based on the same entity (i.e., the printing or other feature on the individual product to be converted) that is the very object that drives the need for making the correct alignment before converting the product. As such, the techniques described herein may achieve a higher degree of alignment accuracy than conversion stations that are based on fiducial marks on unused portions of the web.

As one example, the disclosure is directed to a conversion station comprising: a mechanism operable to support at least some portion of a manufactured web; a conversion device located above the mechanism, the conversion device operable to traverse a conversion zone located below the conversion device to bring a cutting member into contact with the web to convert the web into one or more individual products; an image capturing device located above the mechanism and adjacent to the conversion device but outside the conversion zone, the image capturing device positioned at a non-perpendicular imaging angle relative to a surface plane of the web, the image capturing device operable to capture image information by imaging the one or more features located on the web while the features are positioned within the conversion zone; and a control system operable to align the web within the conversion zone based on the image information.

As another example, the disclosure is directed to a method comprising: aligning a manufactured web for conversion at a conversion station based on a feature of the web that will remain within an area of the web designated to become an individual product once the individual product is converted from the web, wherein aligning the web includes imaging the feature of the web using an image capturing device that is located outside a conversion zone of the conversion station and at an imaging angle relative to the web, and positioning the web within the conversion station based on imaging information captured by imaging the feature on the web while the feature is positioned within the conversion zone, and actuating the conversion station to convert the individual product from the web.

In an additional example, the disclosure is directed to a system comprising a mechanism operable to support at least some portion of a manufactured web, a conversion station comprising a press and at least one die, the press and the at least one die positioned above the mechanism and above the web, and operable to traverse a conversion zone to bring the at least one die into contact with the web to cut through a thickness dimension of the web, an image capturing device located above the mechanism and adjacent to the conversion device but outside the conversion zone, the image capturing device operable to capture image information of a feature located on the web while the feature is positioned within the conversion zone, a control/drive system coupled to the press and to the image capturing device, the control/drive system operable to convey the web to bring areas of the web designated to be converted into individual products into the conversion station, to receive imaging information from the image capturing device, to align the web into a position below the at least one die based on the imaging information and at a position so that when the at least one die is actuated to traverse a conversion zone between the die and the web, the die cuts the web to provide an individual product having a dimension between the feature located on the web and an edge of the converted individual product within an specified range.

### BRIEF DESCRIPTION OF DRAWINGS

The details of one or more examples of this disclosure are set forth in the accompanying drawings and the description below. Other features, objects, and advantages of this disclosure will be apparent from the description and drawings, and from the claims.

FIG. 1 is a block diagram illustrating a global network environment in which a conversion control system controls conversion of web material.

FIG. 2 is a block diagram providing a top view of an example process line for converting a web into individual parts in accordance with one or more examples described in this disclosure.

FIG. 3 is a diagram providing a side view of an example a conversion station for converting a web into individual products in accordance with one or more examples described in this disclosure.

FIG. 4 is a flowchart illustrating one or more example methods in accordance with various techniques described in this disclosure.

The drawings and the description provided herein illustrate and describe various examples of the inventive methods, devices, and systems of the present disclosure. However, the methods, devices, and systems of the present disclosure are not limited to the specific examples as illustrated and described herein, and other examples and variations of the methods, devices, and systems of the present disclosure, as would be understood by one of ordinary skill in the art, are contemplated as being within the scope of the present application.

### DETAILED DESCRIPTION OF ILLUSTRATIVE EMBODIMENTS

As noted above, a web may include a plurality of areas designated as individual products that are intended to be separated from the web to form the individual products. In various examples, the separation of the individual products from the web is referred to as the conversion process. In some examples, the conversion process includes aligning the web underneath a mechanical press that includes one or more dies, the mechanical press operable to be lowered onto the web once the web is properly aligned underneath the die or dies, causing the die or dies to contact the web and to cut through the film layer of the web to form the desired individual product or products. Proper alignment of the web underneath the die or dies is extremely important. For example, some webs include printing on the surface of the film forming the web, wherein the printing needs to be properly positioned relative to the edges of the individual product once the individual products are separated (converted) from the web. If the web is misaligned underneath the die when a die is lowered onto the web, the printing on the resulting individual product(s) will not properly align with or can be improperly spaced from an edge of resulting individual product, and may be rendered unfit for its intended purpose in a final product for which the individual product is intended to be used.

In conventional techniques used to properly align the web underneath a die before performing the conversion process, a fiducial mark or some other type of marking, is applied to the web in an area outside the area of the web designated to be part of an individual product once the individual product is converted from the web. This allows for imaging of the fiducial mark (or other type of marking) without the imaging devices used to locate the mark creating an obstruction relative to the motion of the mechanical press and the die when the actual conversion process is being performed. For example, a dot printed on the surface of the film in an area next to or nearby the area of the web designated to become an individual product can be used as a basis for alignment of the web underneath the die when preparing to convert that particular individual product. Alignment of the web underneath the die is based on imaging the fiducial mark or other marking, and aligning the web based on the position of the fiducial mark or other marking. However, because the film itself is somewhat flexible, stretching or other distortion of the film (or other reasons) can result in an error in the alignment of the fiducial mark relative to the area of the individual product associated with the fiducial mark or other mark, especially because the mark used as a basis for the alignment is outside the area of the web designated to become the individual product.

This disclosure describes example conversion stations and alignment processes that are based on a printed mark or other printing or feature that is to remain on the individual product itself after the individual product has been converted. As recognized herein, this approach provides advantages in that alignment is now based on the same entity (i.e., the printing or other feature on the individual product to be converted) that is the very object that drives the need for making the correct alignment before converting the product. As such, the techniques described herein may achieve a higher degree of alignment accuracy than conversion stations that are based on fiducial marks on unused portions of the web.

As described herein, when basing alignment on printing or other features that are to remain on the individual product itself, the system used to obtain the image of the printing or other feature, and to thus provide information related to the alignment of web, must still not create an obstacle for the mechanical press and the die during the actual conversion process. The example implementations described herein provide for alignment of a web underneath a mechanical press and die, while providing alignment based on printing or other features within the areas of the web that will remain a part of the individual product after conversion of the individual product, and that does not interfere with the actuation of the mechanical press and die during the conversion process. In various examples, the web material includes printed features on a surface of the web, or on a layer of the web made so that the printing is visible from one or both surfaces of the web.

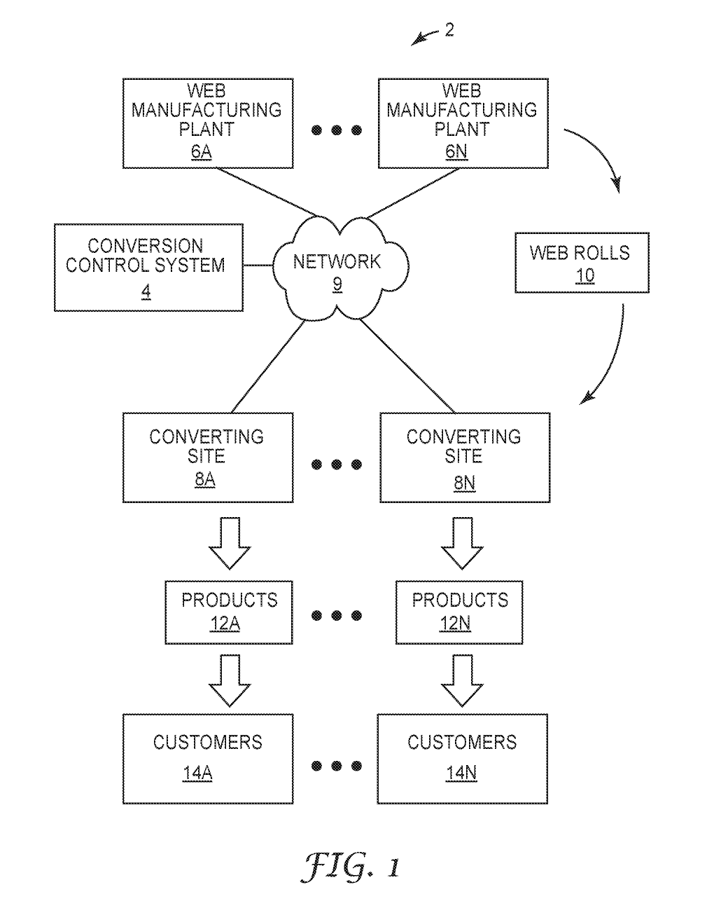

FIG. 1 is a block diagram illustrating global network environment 2 in which conversion control system 4 controls conversion of web material. More specifically, web manufacturing plants 6A-6N represent manufacturing sites that produce and ship web material in the form of web rolls 10. Web manufacturing plants 6A-6N may be geographically distributed. The manufactured web material may include any sheet-like material having a fixed dimension in one direction and either a predetermined or indeterminate length in the orthogonal direction. Examples of web materials include, but are not limited to, metals, paper, wovens, non-wovens, glass, polymeric films, flexible circuits or combinations thereof. Metals may include such materials as steel or aluminum. Wovens generally include various fabrics. Non-wovens include materials, such as paper, filter media, or insulating material. Films include, for example, clear and opaque polymeric films including laminates and coated films. As used herein, the term “film” broadly applies to any web material, including web material comprising multiple layers of different materials forming a composite web material, a material having one or more coatings applied to the material or a coating located with the web material, or a layer comprising a single layer of material forming the web material.

For many applications, the web materials of web rolls 10 may have an applied coating, which generally is applied to an exposed surface of the base web material. Examples of coatings include adhesives, optical density coatings, low adhesion backsize coatings, metalized coatings, optically active coatings, electrically conductive or nonconductive coatings, or combinations thereof. The coating may be applied to at least a portion of the web material or may fully cover a surface of the base web material. Further, the web materials may be patterned or unpatterned.

In some examples, web rolls 10 are shipped to converting sites 8A-8N, which may be co-located within web manufacturing plants 6A-6N or geographically distributed within different regions or countries. Converting sites 8A-8N (“converting sites 8”) convert each web roll 10 into one or more products. Specifically, each of converting sites 8 includes one or more process lines that physically cut the web for a given web roll 10 into numerous individual sheets, individual parts, or numerous web rolls, referred to as products 12A-12N. As one example, converting site 8A may convert web rolls 10 of film into individual products for use as a cover sheet or layer for mobile phone displays or computer monitors. Similarly, other forms of web materials may be converted into products 12 of different shapes and sizes depending upon the intended application by customers 14A-14N. Each of converting sites 8 may be capable of receiving different types of web rolls 10, and each converting site may produce different products 12 depending on the location of the converting site and the particular needs of customers 14.

In converting patterned films into individual parts or individual products, it is often desired to cut the parts in registration with features inherent to the final part itself. A simple example of a feature inherent in the final part that is to become an individual product is a black line or a series of black lines on optical films. In various examples, it is desired to cut the part edge to within a dimension measuring 100 μm of the black line that is to remain on the final product. It is common in the art to use features external to the final part for registration, such as the fiducial marks and imaging techniques described with respect to registration based on fiducial marks. Examples of fiducial marks include images that may be printed or otherwise formed on or within a web material. Fiducial marks in some examples can be crosshair or “X” shapes, or for example a dot, a square, or a rectangular (bar) shape, having a solid color, which is printed onto or embedded in the web material. The fiducial mark is used to determine a position of one or more features on the web relative to the fiducial mark, and in general is not intended to be a feature of the final product that is to be converted from the web. The fiducial marks are often placed at regular intervals throughout the length of a web in order to accurately locate and uniquely identify a physical location on the web. In general, the fiducial mark(s) are located on a portion of the web that will not ultimately become a part of a final (salable) product that is to be converted from the web. However, as recognized herein reliance on features such as fiducial marks that are external to the final product may lead to error in the overall alignment because the external fiducial marks are located at an increased distance from the feature of interest on the product, such as but not limited to the black line or lines printed within the area of the web designated to become an individual product. This increased uncertainty can be caused by the printing process with the fiducial marks not accurately registered to the feature of interest for all parts. It can also be caused by errors in the converting press or laser converting operation in translating the position of the fiducial mark to the position of the feature of interest within the part.

As recognized herein, it can therefore be beneficial to register a part during the conversion process directly to the feature of interest, such as but not limited to the black line or lines printed on a surface of the web within the area(s) of the web designated to become an individual product. Typically, imaging cameras are used to locate feature on the web for registration purposes. Since this feature is within the area of the web designated to be the individual part itself, which is also within the active punch area (conversions zone) of the press used for the conversion process, positioning of the image capturing device used to image the feature is therefore mechanically constrained. In other words, it is not generally practical to image features on web in a part of the web within the punch area at an angle perpendicular to the web. Because of this, for standard imaging devices, it is then not possible to focus across the entire image of the feature contained within the area of the web designated to become the individual product, and therefore not generally possible to accurately register the feature using standard techniques. Hence, the common practice of using an added fiducial mark outside the punch area resulting in the ensuing accuracy limitations.

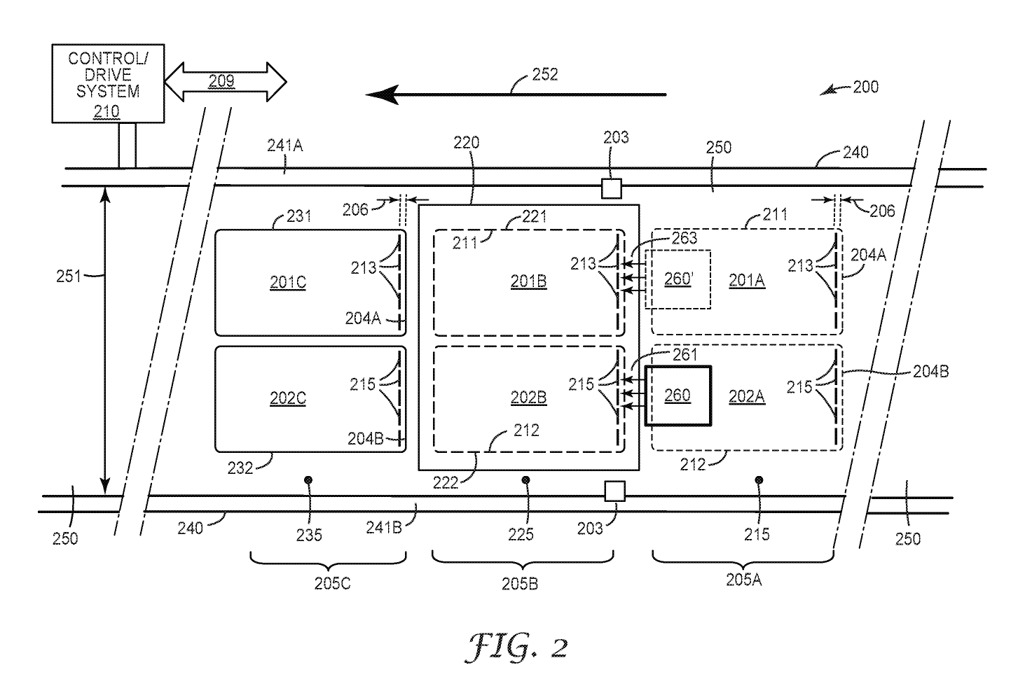

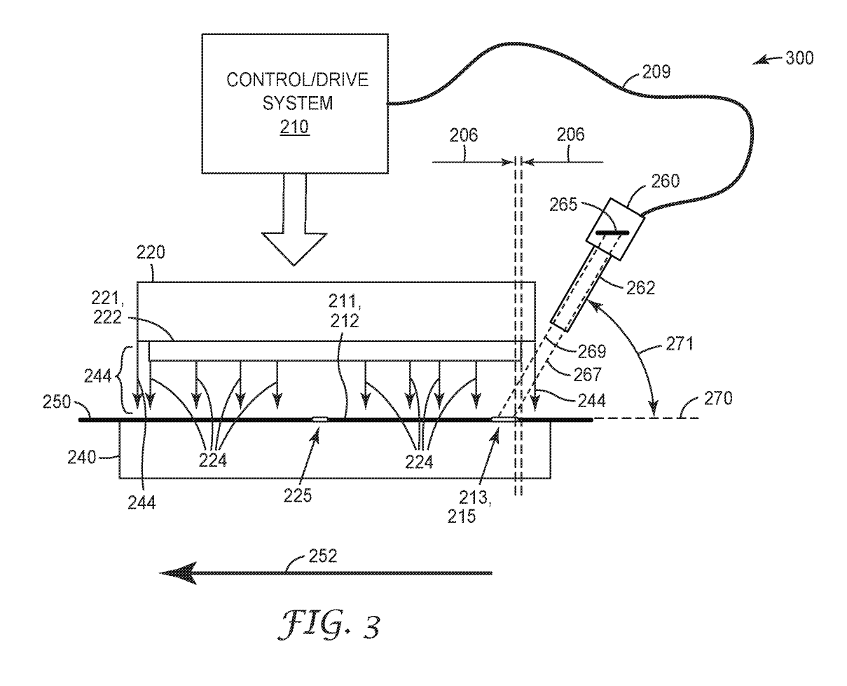

The example implementations described herein provide a plurality of methods that can be incorporated into systems used in the conversion process to convert individual products from a web to overcome these problems. A first example implementation uses a precision telecentric-Scheimpflug lens with an imaging camera to provide highly accurate focus and spatial resolution across the entire field of view that includes features located within an area of the web designated to become an individual product as a result of the conversion process. A second example implementation uses a linear array or line scan camera with precision motion control to accomplish the same highly accurate imaging. In various examples, the first example implementation provides for a high level of system throughput without explicit motion of the image capturing device used to image the features within area of the web designated to become the individual product or products. In addition, these example implementations are applicable to other converting methods such as lasers. These methods are further illustrated and described with respect to FIG. 2 and FIG. 3.

FIG. 2 is a block diagram illustrating a top view of illustrative process line 200 for converting a web into individual parts in accordance with one or more example techniques described with this disclosure. As illustrated, process line 200 comprises supporting mechanism 240 supporting web 250. In various examples, the mechanism is a bottom plate, or some other type of planar surface operable to physically support at least some portion of web 250. In various examples, web 250 can be any sheet-like material, in various examples having a fixed width dimension 251 in one direction and either a predetermined or indeterminate length in the orthogonal direction. In various examples, the length dimension is many, many times greater than the width dimension. As an illustrative example, a web can have a width dimension in a range of 32 inches, wherein a length dimension for the web can be 1000 meters. As another illustrative example, a “sheet” of web material can have a width dimension in a range of 32 inches, wherein a length for the sheet of web material can have a length dimension in a range of 48 inches. However, these are only examples provided with the understanding that these sizes can vary significantly. In example implementations as described herein, web 250 is operable to be conveyed along process line 200 to move portions of web 250 into and out of the various positions along process line 200, as further described below. In various example implementations as described herein, web 250 comprises sheets of material, each sheet having a fixed width dimension as well as a fixed longitudinal dimension, the sheets including one or more areas designated to be converted into individual products, and are operable to be fed into, positioned within, and removed from the conversion station on an individual sheet-by-sheet basis. The example implementations as described herein are applicable to perform alignment and conversion of web 250 when web 250 is conveyed through process line 200 as a continuous length of web material, or in various implementations when provided to process line 200 as individual sheets.

As shown in FIG. 2, web 250 is operable to be conveyed on mechanism 240 in a direction along the length dimension of the web, as represented by arrow 252. As illustrated, width dimension 251 of web 250 is sufficient to allow a layout of two individual products, in one example individual products 201A, 202A, adjacent to each other along the width dimension of web 250. It would be understood that the number of individual products that can be arranged in a width dimension 251 of web 250 can vary from one individual product to a plurality of individual products. The number of products that can be arranged across width dimension 251 of web 250 is not limited to a particular number of individual products, and can vary based on the dimensions and shape(s) of the individual products and width dimension 251.

Process line 200 is operable to position web 250 at various positions along mechanism 240. As illustrated, position 205A represents a first position at which point web 250 includes products 201A and 202A occupying web regions adjacent to each other and having substantially a same end position 204A, 204B respectively, relative to the length dimension of web 250. That is, the area of web 250 at position 205A includes a designated area for individual product 201A enclosed by dashed line 211, and representative of an area of web 250 that is to be converted to an individual product. As illustrated, web 250 at position 205A includes a second designated area for individual product 202A, enclosed by dashed line 212, and representative of an area of web 250 that is to be converted to another individual product. Conversion of the individual products 201A and 202A can occur when web 250 is cut through the thickness dimension of the web material along the outlines formed by dashed line 211 and dashed line 212 to form individual products cut from web 250. In various examples, position 205A can include one or more fiducial marks 216 located outside the designated areas for the individual products, but in an area on web 250 adjacent to the individual products. As illustrated, individual product 201A includes printed features 213, illustrated as a series of line segments within dashed line 211 and near edge 204A, and individual product 202A includes printed features 215, illustrated as a series of line segments within dashed line 212 and located near edge 204B. In various examples, dimension 206 between printed features 213 and edge 204A is a critical dimension, and if the product eventually converted from the web 250 to form individual product 201A does not include dimension 206 within a specified range, individual product 201A will be considered defective and not usable for its intended purpose. In various examples, dimension 206 between printed features 215 and edge 204B is a critical dimension, and if the product eventually converted from web 250 to form individual product 202A does not include dimension 206 within a specified range, individual product 202A will be considered defective and not usable for its intended purpose.

Position 205B illustrates a second position along process line 200 that includes press 220 and dies 221 and 222. In various examples, position 205B of the web processing system is referred to as the conversion station because position 205B is the position along process line 200 were the actual conversion of the individual products from web 250 is operable to occur. As illustrated, at position 205B, web 250 includes individual product 201B and 202B positioned adjacent to one another in a similar manner as described with respect to individual products 201A and 202A. Individual product 201B is positioned under press 220 and die 221 so that a cut pattern provided by die 221 aligns above dashed line 211 and matches the outline shape of the dashed line 211 in such a way that when die 221 is lowered onto and into contact with web 250, die 221 cuts through the thickness dimension of web 250 to form individual product 201B having a shape matching dashed line 211. Similarly, individual product 202B is positioned under press 220 and die 222 so that a cut pattern provided by die 222 aligns above dashed line 212 and matches the outline shape of dashed line 212 in such a way that when die 222 is lowered onto and brought into contact with web 250, die 222 cuts through the thickness dimension of web 250 to form individual product 202B having shape matching dashed line 212.

In various examples, position 205B includes image capturing device 260 that, as described herein, generates image data for features 215 of product 202B and/or features 213 of product 201B of web 250 when the features are positioned within the area of operation of press 220. In various examples, imaging capturing device 260 comprises a device, such as but not limited to a camera, that is operable to capture image information, represented by arrows 261, related to printing or marking on web 250 that is within the area designated to be individual product 202B. In various examples, image capturing device 260 is operable to provide image information 261 as an output to the drive/control system 210 and/or to press 220 in order to allow proper positioning of individual products 201B and 202B underneath press 220 for the conversion process, as further described below. In various examples, image capturing device 260 is positioned above mechanism 240 and above web 250, and also horizontally adjacent to press 220, but located outside the vertical area of operation (conversion zone) of press 220. In various examples, the area of operation of press 220 includes the area that press 220 and dies 221 and 222 travel through when press 220 moves from a home position above web 250 to a position where dies 221 and 222 are brought into contact with web 250. The position of image capturing device 260 is not limited to the position shown in as illustrative in FIG. 2, and in various examples can be located on the side of press 220 over fiducial mark 225 adjacent to individual product 202B. In various examples, image capturing device 260 is located on the outbound side of press 220 where web 250 is operable to exit position 205B in the direction indicated by arrow 252. In various examples, a determination as to the placement of image capturing device 260 is based on the position of the printing within the individual product that is to be used for image capture and determination of the proper position of the web material relative to press 220. For example, as illustrated in FIG. 2, individual product 202B including printing 215 near the edge of an area designated as individual product 202B that trails the leading edge relative to the direction of travel of web 250 through process line 200. In this instance, image capturing device 260 is placed adjacent to press 220 at the inbound side of position 205B so that when individual product 202B is in the proper position within position 205B for conversion, printing 215 is relatively close to the side of press 220 where image processing device 260 is positioned. However, the location of image capturing device 260 may be set to other locations relative to press 220 for different printing patterns or features used for different individual products, and the location of image capturing device 260 as illustrated in FIG. 2 is merely illustrative of one such position.

Further, various examples of position 205B are not limited to comprising a single image capturing device, and in some examples can include a plurality of image capturing devices. An example of an additional image capturing device 260 is illustrated by the dashed box adjacent to individual product 201B and dies 221 in FIG. 2. In a manner similar to that described above with respect to image capturing device 260, image capturing device 260′, when included at position 205B can be positioned above mechanism 240 and above web 250, and adjacent to press 220 but located outside the area of operation of press 220. In various examples, image capturing device 260′ comprises a device, such as but not limited to a camera, that is operable to capture image information, represented by arrows 263, related to printing or other features on web 250 that are within the area designated to be individual product 201B. In various examples, image capturing device 260′ is operable to provide image information 263 as an output to the drive/control system 210 and to press 220 in order to allow proper positioning of individual product 201B and 202B, or (in some examples only individual product 201B) underneath press 220 for the conversion process. Further, in examples where only one image processing deice 260 is included at position 205B, the particular individual product or products being imaged by the image capturing device is not limited to the example as illustrated in FIG. 2, wherein image capturing device 260 can be located to capture image information based on printing 213, based on printing 215, or based on both printing 213 and on printing 215.

Process line 200 is not limited to having a particular number of individual products adjacent to one and other along width dimension 251 of web 250 to be at position 205B at a given time, and is not limited to having a particular number of image capturing devices located at position 205B relative to the number of individual products adjacent to one and other along width dimension 251 of web 250 at position 205B at a same time. In some examples, only a single image capturing device 260 is included at position 205B. In other examples, a plurality of image capturing devices are included at position 205B. In some examples, the number of image capturing devices located as position 205B equals the number of individual products located adjacent to one another along width dimension 251 of web 250 at position 205B, wherein each image capturing device is positioned to capture image information related to printing or other features on a single one of the individual products at position 205B. In various examples, the total number of image capturing devices at position 205B is less than the total number of individual products adjacent to one and other along width dimension 251 of web 250 at position 205B.

It would be understood that the arrangement of individual products on web 250 that can be positioned for conversion at position 205B is not limited to individual products being adjacent to one another, and for example can be in other geometric arrangements, such as but not limited to linear arrangements relative to the longitudinal axis of web 250. Placement of the one or more image capturing devices can be made at different locations at position 205B based on the particular arrangement of individual products being converted from web 250 at a given time.

As illustrated, position 205C illustrates a third position along process line 200 at which point web 250 includes illustrative individual products 201C and 202C. Individual product 201C is illustrative of an individual product that has been converted (i.e., cut through a thickness dimension of web 250) to a shape shown as enclosure 231. Individual product 201C includes printing 213 that now resided at distance 206 from trailing edge 204A, distance 206 determined by control of the positioning of individual product 201C under press 220 when individual product 201C was previously positioned at position 205B and converted by the operation of press 220 and die 221. Similarly, individual product 202C is illustrative of an individual product that has been converted (i.e., cut through a thickness dimension of web 250) to a shape shown as enclosure 232. Individual product 202C includes printing 215 that now resided at distance 206 from trailing edge 204B, distance 206 determined by control of the positioning of individual product 201C under press 220 when individual product 201C was previously positioned at position 205B and converted by operation of press 220 and die 222. As illustrated in FIG. 2, individual products 201C and 202C are separated from web 250, but still reside inside their respective cutout areas of web 250. Therefore, individual products 201C and 202C are conveyed along in these positions whenever web 250 is moved along mechanism 240. It would be understood that now that individual products 201C and 202C have been converted, they would be operable to be removed from web 250 at position 205C, or some other position downstream from position 205C by such means operable to separate individual products 201C and 202C for further processing, including in some examples inspection and packaging for shipment to a customer. In various examples, position 205C includes fiducial mark 235 located on web 250 adjacent to one of individual products 201C, 202C.

In operation, control/drive system 210 is operable to convey web 250 along mechanism 240 in a direction indicated by arrow 252. In various examples, mechanism 240 includes side rails 241A, 241B that are operable to provide a set of edges rising above mechanism 240 at a spacing substantially equal to width dimension 251 of web 250 in order to provide lateral positioning of web 250 under press 220 at position 205B relative to the width dimension 251 of web 250. In various examples, process line 200 includes one or more sensors 203 coupled to control/drive system 210, wherein control/drive system 210 is operable to provide lateral positioning control of web 250 along width dimension 251 relative to press 220 at position 205B. In addition, control/drive system 210 is operable to precisely convey web 250 along the longitudinal axis of web 250, as represented by arrow 252, in order to position individual products 201B and 202B below press 220 and dies 221 and 222 so that when press 220 is operated to convert individual product 201B and 202B, the dimension 206 between printing 213 and 215 on these individual products, respectively, has a dimension 206 from trailing edge 204A, 204B respectively that is within the acceptable tolerance for the final products individual product 201B and 202B are intended to be incorporated into.

In various examples, proper alignment of one or more individual products for conversion at the conversion station is not limited to a particular alignment process or a particular positioning mechanism. In various examples, the web is conveyed into the conversion station in a direction, such as the direction shown in by arrow 252, and proceeds in the conveyed direction until proper alignment of the one or more individual products under the conversion station is achieved. In various examples, one or more different speeds are used to convey the web into position for proper alignment at the conversion station. For example, a first faster speed can be used to convey the web into the conversion station to a position that is short of the proper alignment position for converting the one or more individual products, wherein one or more slower speeds are then used for the final proper alignment of the one or more individual products for conversion. In various examples that utilize such a multi-speed alignment technique, image scanning, as described herein, of the one or more individual products can be incorporated into the process of conveying the web at the one or more slower speeds to allow for conveyance of the web to the desired and proper alignment position at the conversion station.

In various examples, the web is conveyed and positioned at an initial position under the conversion station, and the final proper alignment of the one or more individual products at the conversion station is provided by moving the press, and/or the dies located at the conversion station, to properly position and align the die or dies with the one or more individual products to be converted. In various examples, control/drive system 210 includes one or more positioning mechanisms (not shown in FIG. 2) operable to allow control/drive system 210 to adjust the position of press 220 and/or individual dies 221 and 222 to provide proper alignment of the dies for conversion of the one or more individual products positioned at the conversion station. In various examples, positioning of press 220 and/or individual dies 221 and 222 is based on imaging one or more features located within the areas designated to become the one or more individual products after the one or more individual products have been conveyed to the initial position under the conversion station.

In various examples, instead of web 250 having a width dimension and a length that is many, many times the width dimension, or having an indeterminate length dimension, web 250 can comprise individual sheets having a width dimension and a predetermined length dimension so that the web comprises a series of individual sheets, each individual sheet having an area designated to become one or more individual products once the individual product or products are converted from the web. In various examples, the sheets can be fed into the conversion station one sheet at a time, and positioned for example using stops, crowders, or other positioning mechanisms (none shown in FIG. 2) as would be understood by one of ordinary skill in the art. In various examples, an individual sheet can be held in position at the conversion station mechanically, such as by a clamping mechanism, or for example by a vacuum applied to the web. In various examples, once a sheet is initially positioned at the conversion station, final alignment of the sheet for conversion can be accomplished by moving the sheet, moving the press and or dies at the conversion station, or a combination of moving the sheet and moving the press/dies. After conversion of the sheet is completed, the sheet with the now converted individual product or products can be removed from the conversion station, and the process of positioning another (unconverted) sheet at the conversion station is then repeated.

In various examples, when a conversion process of the individual products at position 205B is completed and press 220 has raised dies 221 and 222 back to a position above web 250, control/drive system 210 begins to convey web 250 along mechanism 240 in the direction indicted by arrow 252. As web 250 is conveyed, the converted products previously positioned at position 205B are conveyed outbound from position 205B toward position 205C. The next individual product or products at position 205A are also conveyed inbound toward position 205B for positioning under press 220. As the individual product or products are brought into position under press 220, in various examples image capturing device 260 captures image data related to printing 215 on individual product 202B. Image capturing device 260 provides image information 261 to control/drive system 210, representative by arrow 209, that control/drive system 210 is operable to use to finalize the position of individual product 202B within position 205B and aligned with die 212. In various examples, once individual product 202B is properly aligned under die 222 based on image information 261 provided by image capturing device 260, control/drive system 210 is operable to have press 220 actuate and traverse the conversion zone to bring die 222 into contact with web 250 in order to cut web 250 to form individual product 202B converted from web 250. In various examples, operation of press 220 also operates die 221 at the same time as die 222, and thus the operation of press 220 also results in individual product 201B being cut from web 250 to form individual product 201B converted from web 250. Once the press 220 has converted both individual products 201B and 202B, press 220 and dies 221, 222 can be raised above web 250 to allow web 250 to again be conveyed to move the now converted individual products 201B, 202B outbound from position 205B, and in various examples to again bring in another pair of individual products previously positioned at position 205A. The converted individual products leaving position 205B can be conveyed along with web 250, and at some point removed from web 250 as individual products for further processing.

By using image information from image capturing device 260 to control positioning of web 250 within position 205B and relative to press 220 and dies 221, 222, process line 200 is operable to perform registration and alignment of individual products 201B, 202B based on features such as printing 215 that is located on web 250 within an area designated to become part of the actual individual product after being converted from the web, while utilizing an image capturing device located adjacent to press 220 and dies 221, 222 but still outside the conversion zone for press 220.

In various examples that include both image capturing device 260 and a second image capturing device such as image capturing device 260′, process line 200 can be operable to align individual product 201B separately for conversion from individual product 202B. For example, press 220 can be operable to lower die 221 and die 222 individually so that when die 221 is lowered onto web 250 only individual product 201B is converted, and die 222 can be lowered on to web 250 at a different time so that only individual product 202B is converted at that time. In this example instance, web 250 can be conveyed into position 205B until one of image capturing devices 260, 260′ provides imaging information indicating that the individual product being imaged by that image capturing device is properly aligned under the corresponding die used to convert that individual product. At that point the corresponding die can be actuated to convert the properly aligned individual product, while the second die remains in the home or raised position. After converting the individual product that was properly aligned, and the die performing the conversion is raised back above web 250. Process line 200 can then continue to convey web 250 until the image capturing device that is imaging the not yet convert individual product provides imaging information indicating that the not yet converted individual product is now properly aligned under the corresponding die for converting that individual product. At that point the corresponding die can be actuated to convert the properly aligned individual product, while the first die remains in the home or raised position. Once the corresponding (second) die is again raised above web 250, process line 200 can convey both converted individual products outbound from position 205B. By using these techniques, variations, such as printing variations, between the printing or other features relative to individual products adjacent one another can be compensated for by using individual image capturing and individual conversions to maintain the required dimensions for the converted individual products.

The above description of the converting station at position 205B has been described in terms of a mechanical press and dies. However, alternative means for cutting the web at converting station are contemplated. For example, instead of using a mechanical press and one or more dies, process line 200 can comprise other devices, such as but not limited to a laser device (illustrated as 220 in FIG. 3) operable to provide a laser light (illustrated as arrows 224) that cuts the web located at position 205B in order to convert web 250 into individual products. As referred to in this disclosure, the term “cutting member” can be any devices and forms of energy created by these devices, such as but not limited to mechanical press and die(s), or a laser device and the laser light (laser beam) generated by the laser device, that are operable to convert the individual product or products from web 250.

As described above, process line 200 is able to provide individual products having dimensions for printing or other features relative to the edges of the individual product that maintain a high degree of accuracy with respect to these dimensions. In various examples, using the example implementations and techniques described above and further described with respect to FIG. 3, tolerances for dimensions such as dimension 206 as shown in FIG. 2 can be achieved in the range of ±10 μm.

In various examples, process line 200 comprises one or more process lines included in one or more of converting sites 8A-8N illustrated and described with respect to FIG. 1. However, examples of process line 200 are not limited to any particular process line or to any particular converting site, and can be employed in any process line operable for converting individual products from a web based on the example implementations and techniques described herein, and any and all equivalents thereof.

FIG. 3 is a diagram providing a cross-web view of an example conversion station 300 for converting web 250 into individual products in accordance with one or more examples described in this disclosure. In various examples, conversion station 300 is the conversion station illustrated as position 205B in process line 200, although examples of conversion station 300 are not limited to any particular process line. As illustrated in FIG. 3, elements of conversion station 300 that correspond to same or similar elements as illustrated for position 205B in FIG. 2 retain a same reference number in FIG. 3. As illustrated in FIG. 3, conversion station 300 includes mechanism 240 supporting web 250. Conversion station 300 is operable to position web 250 below press 220 and dies 221, 222 by conveying web 250 in at least the direction indicated by arrow 252. Other directional movements of web 250 are contemplated in the process of positioning web 250 relative to press 220 and dies 221, 222. For example, lateral positioning of web 250 as described above for process line 200 can be incorporate into the positioning of web 250 in conversion station 300. As illustrated in FIG. 3, web 250 comprises one or more individual products designated by an area enclosed by dashed lines 211, 212. In various examples, image capturing device 260 is positioned adjacent to press 222 and dies 221, 222, but in a position so that the entirety of image capturing device is outside the conversion zone, represented by arrows 244, of the press 220 and dies 221, 222. In various examples, conversion zone 244 is the area traversed by press 220 and dies 221, 222 when press 220 and one or more of dies 221, 222 moves from a home position, as illustrated in FIG. 3, to a position where one of or more of dies 221, 222 are brought into contact with web 250 in order to have one or more of dies 221, 222 cut though the dimensional thickness of web 250.

According to the techniques described herein, image capturing device 260 is positioned at imaging angle 271 relative to surface plane 270 of web 250. When imaging in this manner, image capturing device 260 is not square (perpendicular) to the web, and therefore for most imaging systems it is not possible to retain focus across the entire field of view. For example, with traditional imaging systems in general with imaging at an angle such as imaging angle 271, in some instances only the center of the image is in focus while the top and bottom are both blurry. In various example implementations described herein, to overcome this problem image capturing device 260 is also operable to provide Scheimpflug imaging, along with tele-centric imaging with a single lens. This allows both focus and spatial resolution to be controlled to the desired accuracy while imaging printed features 213, 215 at imaging angle 271 relative to web 250 across the entire field of the image being captured. Scheimpflug imaging is a technique that configures an image sensing array, such as image sensing array 265 as shown in FIG. 3 at a tilted position relative to lens 262 and relative to the image plane represented by plane 270 in FIG. 3. Using Scheimpflug imaging, image capturing device 260 is operable to provide focused images across the entire field being imaged, as represented by the area between dashed lines 267 and 269. Using this technique, image capturing device 260 is operable to capture high resolution image information across the entire field being imaged, without having to physically move image capturing device 260 during the image capturing process.

Image capturing device 260 in not limited to any particular type of image capturing device. In various examples, image capturing device 260 is a camera comprising lens 262 and sensing array 265 within image capturing device 260 that is operable to be tilted to an imaging angle relative to lens 262. In various examples lens 262 is a telecentric lens. Teleceniric lens are operable to provide an orthographic projection, which provides the same magnification for objects at all distances from the lens. In various examples, image sensing array 265 is adjusted to a particular angle to compensate for the angled position used to allow image capturing device 260 to be located outside conversion zone 244 and still image printed features 213, 215 that are located in areas designated to be within the individual product or products when the individual product or products are aligned for conversion under press 220. In various examples, Scheimpflug imaging provides a calculation for the amount of tilt provided to image sensing array 265 to achieve focus over the entire field of vision based on a focal length of lens 262, a value of angle 271, a distance between lens 262 and a point along a line of sight from lens 262 to surface plane 270 where web 250 is being imaged.

As illustrated in FIG. 3, first vector 267 has a distance from lens 262 of image capturing device 260 that is shorter than a distance of second vector 269 from web 250 to lens 262. This difference in distances between web 250 and lens 262 from one side of lens 262 (vector 267) the other side of lens 262 (vector 269) can result in a distortion of the image received at image capturing array 265 when imaging with a traditional image capturing device. By tilting image array 265 at an angle based on Scheimpflug imaging techniques, image capturing device 260 is operable to provide accurate image data across the entire field of the image being captured, and can output the imaged information as output data to control/drive system 210 in order to properly position individual product or products designed by dashed lines 211, 212 relative to press 220 and dies 221,222 for conversion.

In various examples, image capturing device 260 is operable to capture images related to one or both of printed features 213, 215. In various examples, printed features 213 and 215 are printing on the surface or visible at the surface of web 250 and within the area or areas designed as an individual product or products, such as individual products 201B, 202B shown in FIG. 2. As illustrated in FIG. 3 printed features 213, 215 and are located at distance 206 from a trailing edge designated by dashed line 211, 213 respectively. Image capturing device 260 is positioned above web 250, adjacent to press 220 and dies 221, 222, but outside conversion zone 224, and mounted at imaging angle 271.

In various examples, image capturing device 260 is operable to provide an output of image information, through a communication channel represented by connection 209, to control/drive system 210 so that control/drive system 210 is operable to convey web 250 to properly position individual products under press 220 and one or more of dies 221, 222. Once web 250 is properly positioned under press 220, press 220 is actuated and traverses conversion zone 244, wherein one or more of dies 221, 222 are brought into contact with web 250, and cut web 250 to form one or more individual products having a proper dimension 206 between printing features 213, 215 and an edge of the individual product or products being converted. The imaged information and output data provided by image capturing device 260 are not limited to any specific types of information, and are not limited to any particular data formats. The image information and data can comprise any type of information or data operable to be provided by image capturing device 260 that can be received by control/drive system 210 and used by control/drive system 210 to align web 250 relative to press 220 and dies 221, 222 for conversion by press 220 resulting in a proper dimension 206 after the conversion process has been completed.

In various examples, image capturing device 260 is a line scan camera, and image capturing device 260 is mounted in a manner similar to that described above, having imaging angle 271, but in a manner that allows the line scan camera to be moved in a pattern that allows the line scan camera to capture the image of printed featured 213 and 215. In various examples, the line scan camera is operable to focus in one direction, and is physically moved in a second direction to form a two-dimensional image of printed features 213, 215 being used as a basis for positioning of web 250 under press 220 for the conversion process.

By using a printed features printed on web 250 that are also within the areas designated to become individual products as the image information used for aligning the press and die(s) for the conversion process, conversion station is able to provide individual products having dimensions for printing or other features relative to the edges of the individual product (such as but not limited to dimension 206) that maintain a high degree of accuracy with respect to these dimensions.

In various examples, conversion station 300 is the conversion station provided at position 205B in FIG. 2 can include any one or more of the features, functions, and capabilities described above with respect to process line 200. However, examples of conversion station 300 are not limited to any particular process line or to any particular converting site, and can be employed as a conversion station in any process line or process operation operable for converting individual products from a web based on the example implementations and techniques described herein, and any and all equivalents thereof.

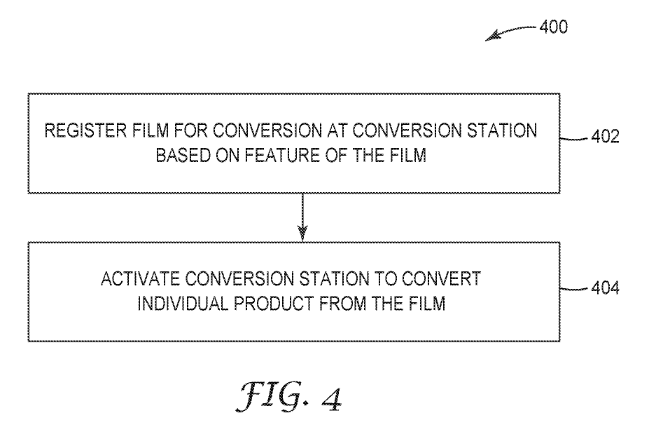

FIG. 4 is a flowchart illustrating one or more example methods 400 in accordance with various techniques described in this disclosure. Although discussed with respect to process line 200, the techniques may be implemented, at least in part, by conversion station 300 shown in FIG. 3. In various examples, process line 200 aligns a web for conversion at a conversion station based on a feature of the web that will remain within an area of the web designated to become an individual product once the individual product is converted from the web (block 402). In various examples, process line 200 aligns the web by imaging the feature of the web using an image capturing device that is located outside a conversion zone of the conversion station and at an imaging angle relative to the web. In various examples, process line 200 then positions the web within the conversion station based on imaging information captured by imaging the feature on the web while the feature is positioned within the conversion zone. In various examples, the image capturing device is positioned above the web and adjacent to the conversion station at the imaging angle to the web, wherein a line of sight from the image capturing device to the feature on the web being imaged forms an angle that is less than 90 degrees relative to a surface of the web. In various examples, the image capturing device allows for adjustment of a tilt angle of an image sensing array included within the image capturing device, the image sensing array operable to be positioned at the tilt angle relative to a lens of the image capturing device. In various examples, adjusting the tilt angle of image sensing array comprises setting the tilt angle to compensate for the angle of the image capturing device relative to a surface of the web, such that when set to the tilt angle, each portion of the feature on the web being imaged is in focus across the entire field of vision of the image capturing device. In various examples, processing line 200 images the feature of the web using a line scan camera.

In various examples, process line 200 aligns the web for conversion at the conversion station based on the feature of the web by imaging printing on a surface of the web, and then positions the web within the conversion station based on imaging information captured by imaging the printing on the surface web. In various examples, process line 200 converts the individual product from the web so that a dimension between the feature included within the individual product and an edge of the individual product has a tolerance of ±10 μm. In various examples, process line actuates the conversion station to convert the individual product from the web (block 404). In various examples, actuation of the conversion station to convert the individual product from the web comprises lowering a press and one or more dies to bring the one or more dies into contact with the web to cut through a thickness dimension of the web.

The techniques of this disclosure may be implemented in a wide variety of computing devices, image capturing devices, and various combinations thereof. Any of the described units, modules or components may be implemented together or separately as discrete but interoperable logic devices. Depiction of different features as modules, devices, or units is intended to highlight different functional aspects and does not necessarily imply that such modules, devices, or units must be realized by separate hardware or software components. Rather, functionality associated with one or more modules, devices, or units may be performed by separate hardware or software components, or integrated within common or separate hardware or software components. The techniques described in this disclosure may be implemented, at least in part, in hardware, software, firmware or any combination thereof. For example, various aspects of the techniques may be implemented within one or more microprocessors, digital signal processors (“DSPs”), application specific integrated circuits (“ASICs”), field programmable gate arrays (“FPGAs”), or any other equivalent integrated or discrete logic circuitry, as well as any combinations of such components, embodied in programmers, such image capturing devices 260, 261, control/drive system 210, systems or devices used to actuate or to provide the cutting member, such as computer controlled hydraulic or pneumatic devices or lasers, or other devices. The terms “processor,” “processing circuitry,” “controller” or “control module” may generally refer to any of the foregoing logic circuitry, alone or in combination with other logic circuitry, or any other equivalent circuitry, and alone or in combination with other digital or analog circuitry.

For aspects implemented in software, at least some of the functionality ascribed to the systems and devices described in this disclosure may be embodied as instructions on a computer-readable storage medium such as random access memory (“RAM”), read-only memory (“ROM”), non-volatile random access memory (“NVRAM”), electrically erasable programmable read-only memory (“EEPROM”), FLASH memory, magnetic media, optical media, or the like that is tangible. The computer-readable storage media may be referred to as non-transitory. A server, client computing device, or any other computing device may also contain a more portable removable memory type to enable easy data transfer or offline data analysis. The instructions may be executed to support one or more aspects of the functionality described in this disclosure. In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

The following exemplary embodiments describe one or more aspects of the disclosure.

Embodiment 1. A conversion station comprising: a mechanism operable to support at least some portion of a manufactured web; a conversion device located above the mechanism, the conversion device operable to traverse a conversion zone located below the conversion device to bring a cutting member into contact with the web to convert the web into one or more individual products; an image capturing device located above the mechanism and adjacent to the conversion device but outside the conversion zone, the image capturing device positioned at a non-perpendicular imaging angle relative to a surface plane of the web, the image capturing device operable to capture image information by imaging the one or more features located on the web while the features are positioned within the conversion zone; and a control system operable to align the web within the conversion zone based on the image information.

Embodiment 2. The conversion station of Embodiment 1, wherein the image capturing device comprises a tiltable image sensing array, the image sensing array tiltable at an adjustable tilt angle to provide Scheimpflug imaging across an entire field of view of the image capturing device.

Embodiment 3. The conversion station of Embodiment 2, wherein the image capturing device comprises a telecentric lens.

Embodiment 4. The conversion station of either of Embodiments 1 or 2, wherein the image capturing device comprises a telecentric lens.

Embodiment 5. The conversion station of any of Embodiments 1-4, wherein the image capturing device is a line scan camera.

Embodiment 6. The conversion station of any of Embodiments 1-5, wherein the one or more features are located within an area of the web designated as an individual product to be converted from the web.

Embodiment 7. The conversion station of any of Embodiments 1-6, wherein the individual product comprises a cover sheet or layer for covering a display of a mobile device, and wherein the features include a series of black lines printed on a surface of the web, the series of black lines operable to block light emissions generated within the mobile device from being visible when the display is viewed from outside the mobile device.

Embodiment 8. The conversion station of any of Embodiments 1-7, wherein the cutting member comprises one or more mechanical dies.

Embodiment 9. The conversion station of any of Embodiments 1-8, wherein the cutting member comprises a laser beam.

Embodiment 10. The conversion station of any of Embodiments 1-9, wherein the conversion station is operable to convert an individual product from the web so that a dimension between the features included within the individual product and an edge of the individual product has a tolerance of ±10 μm.

Embodiment 11. A method comprising: aligning a manufactured web for conversion at a conversion station based on a feature of the web that will remain within an area of the web designated to become an individual product once the individual product is converted from the web, wherein aligning the web includes imaging the feature of the web using an image capturing device that is located outside a conversion zone of the conversion station and at an imaging angle relative to the web, and positioning the web within the conversion station based on imaging information captured by imaging the feature on the web while the feature is positioned within the conversion zone; and actuating the conversion station to convert the individual product from the web.

Embodiment 12. The method of Embodiment 11, further comprising: positioning the image capturing device above the web and adjacent to the conversion station at the imaging angle to the web, wherein a line of sight from the image capturing device to the feature on the web being imaged forms an angle that is less than 90 degrees relative to a surface of the web.

Embodiment 13. The method of any of Embodiments 11-12, wherein imaging the feature of the web comprises: adjusting a tilt angle of an image sensing array included within the image capturing device, the image sensing array operable to be positioned at a tilt angle relative to a lens of the image capturing device, wherein adjusting the tilt angle of image sensing array comprises setting the tilt angle to compensate for the angle of the image capturing device relative to a surface of the web, and wherein when set to the tilt angle, each portion of the feature on the web being imaged is in focus across an entire field of vision of the image capturing device.

Embodiment 14. The method of any of Embodiments 11-13, wherein the lens comprises a telecentric lens.

Embodiment 15. The method of any of Embodiments 11-14, wherein imaging the feature of the web using an image capturing device comprises imaging the feature using a line scan camera.

Embodiment 16. The method of any of Embodiments 11-15, wherein the conversion station is operable to convert the individual product from the web so that a dimension between the feature included within the individual product and an edge of the individual product has a tolerance of ±10 μm.

Embodiment 17. The method of any of Embodiments 11-16, wherein aligning the web for conversion at the conversion station based on the feature of the web comprises: imaging printing on a surface of the web, and positioning the web within the conversion station based on imaging information captured by imaging the printing on the surface web.

Embodiment 18. The method of any of Embodiments 11-17, wherein actuating the conversion station to convert the individual product from the web comprises lowering a press and one or more dies to bring the one or more dies into contact with the web to cut through a thickness dimension of the web.

Embodiment 19. A system comprising: a mechanism operable to support at least some portion of a manufactured web; a conversion station comprising a press and at least one die, the press and the at least one die positioned above the mechanism and above the web, and operable to traverse a conversion zone to bring the at least one die into contact with the web to cut through a thickness dimension of the web; an image capturing device located above the mechanism and adjacent to the conversion device but outside the conversion zone, the image capturing device operable to capture image information of a feature located on the web while the feature is positioned within the conversion zone; and a control/drive system coupled the press and to the image capturing device, the control/drive system operable to convey the web to bring areas of the web designated to be converted into individual products into the conversion station, to receive imaging information from the image capturing device, to align the web into a position below the at least one die based on the imaging information and at a position so that when the at least one die is actuated to traverse a conversion zone between the die and the web, the die cuts the web to provide an individual product having a dimension between the feature located on the web and an edge of the converted individual product within an specified range.

Embodiment 20. The system of Embodiment 19, wherein the image capturing device comprises a tiltable image sensing array, the image sensing array tiltable at an adjustable tilt angle to provide Scheimpflug imaging across an entire field of view of the image capturing device.

Embodiment 21. The system of either of Embodiments 19 or 20, wherein the image capturing device comprises a line scan camera.

Embodiment 22. The system of any of Embodiments 19-21, wherein the features comprise printing on a surface of the web.

Embodiment 23. The system of any of Embodiments 19-22, wherein the lens comprises a telecentric lens.

Various aspects of this disclosure have been described. These and other aspects are within the scope of the following claims.

1. A conversion station comprising:
a mechanism to support at least some portion of a manufactured web;
a conversion device located above the mechanism, the conversion device operable to traverse a conversion zone located below the conversion device to bring a cutting member into contact with the web to convert the web into one or more individual products;
an image capturing device located above the mechanism and adjacent to the conversion device but outside the conversion zone, the image capturing device positioned at a non-perpendicular imaging angle relative to a surface plane of the web, the image capturing device operable to capture image information by imaging the one or more features located on the web while the features are positioned within the conversion zone; and
a control system operable to align the web within the conversion zone based on the image information.

2. The conversion station of claim 1, wherein the image capturing device comprises a tiltable image sensing array, the image sensing array tiltable at an adjustable tilt angle to provide Scheimpflug imaging across an entire field of view of the image capturing device.

3. The conversion station of claim 2, wherein the image capturing device comprises a telecentric lens.

4. The conversion station of claim 1, wherein the image capturing device comprises a telecentric lens.

5. The conversion station of claim 1, wherein the image capturing device is a line scan camera.

6. The conversion station of claim 1, wherein the one or more features are located within an area of the web designated as an individual product to be converted from the web.

7. The conversion station of claim 6, wherein the individual product comprises a cover sheet or layer for covering a display of a mobile device, and wherein the features include a series of black lines printed on a surface of the web, the series of black lines operable to block light emissions generated within the mobile device from being visible when the display is viewed from outside the mobile device.

8. The conversion station of claim 1, wherein the cutting member comprises one or more mechanical dies.

9. The conversion station of claim 1, wherein the cutting member comprises a laser beam.

10. The conversion station of claim 1, wherein the conversion station is operable to convert an individual product from the web so that a dimension between the features included within the individual product and an edge of the individual product has a tolerance off 10 μm.

11. A method comprising:
aligning a manufactured web for conversion at a conversion station based on a feature of the web that will remain within an area of the web designated to become an individual product once the individual product is converted from the web,
wherein aligning the web includes imaging the feature of the web using an image capturing device that is located outside a conversion zone of the conversion station and at an imaging angle relative to the web, and positioning the web within the conversion station based on imaging information captured by imaging the feature on the web while the feature is positioned within the conversion zone; and
actuating the conversion station to convert the individual product from the web.

12. The method of claim 11, further comprising:
positioning the image capturing device above the web and adjacent to the conversion station at the imaging angle to the web, wherein a line of sight from the image capturing device to the feature on the web being imaged forms an angle that is less than 90 degrees relative to a surface of the web.

13. The method of claim 11, wherein imaging the feature of the web comprises:
adjusting a tilt angle of an image sensing array included within the image capturing device, the image sensing array operable to be positioned at a tilt angle relative to a lens of the image capturing device, wherein adjusting the tilt angle of image sensing array comprises setting the tilt angle to compensate for the angle of the image capturing device relative to a surface of the web, and wherein when set to the tilt angle, each portion of the feature on the web being imaged is in focus across an entire field of vision of the image capturing device.

14. The method of claim 13, wherein the lens comprises a telecentric lens.

15. The method of claim 11, wherein imaging the feature of the web using an image capturing device comprises imaging the feature using a line scan camera.

16. The method of claim 11, wherein the conversion station is operable to convert the individual product from the web so that a dimension between the feature included within the individual product and an edge of the individual product has a tolerance off 10 μm.

17. The method of claim 11, wherein aligning the web for conversion at the conversion station based on the feature of the web comprises:
imaging printing on a surface of the web, and
positioning the web within the conversion station based on imaging information captured by imaging the printing on the surface web.

18. The method of claim 11, wherein actuating the conversion station to convert the individual product from the web comprises lowering a press and one or more dies to bring the one or more dies into contact with the web to cut through a thickness dimension of the web.

19. A system comprising:
a mechanism operable to support at least some portion of a manufactured web;
a conversion station comprising a press and at least one die, the press and the at least one die positioned above the mechanism and above the web, and operable to traverse a conversion zone to bring the at least one die into contact with the web to cut through a thickness dimension of the web;
an image capturing device located above the mechanism and adjacent to the conversion device but outside the conversion zone, the image capturing device operable to capture image information of a feature located on the web while the feature is positioned within the conversion zone; and
a control/drive system coupled the press and to the image capturing device, the control/drive system operable to convey the web to bring areas of the web designated to be converted into individual products into the conversions station, to receive imaging information from the image capturing device, to align the web into a position below the at least one die based on the imaging information and at a position so that when the at least one die is actuated to traverse a conversion zone between the die and the web, the die cuts the web to provide an individual product having a dimension between the feature located on the web and an edge of the converted individual product within an specified range.

20. The system of claim 19, wherein the image capturing device comprises a tiltable image sensing array, the image sensing array tiltable at an adjustable tilt angle to provide Scheimpflug imaging across an entire field of view of the image capturing device.

21. The system of claim 19, wherein the image capturing device comprises a line scan camera.

22. The system of claim 19, wherein the features comprise printing on a surface of the web.

23. The system of claim 19, wherein the image capturing device comprises a telecentric lens.
